(19) United States
(12) Patent Application Publication
(10) Pub. No.: US 2010/0284250 A1
(43) Pub. Date: Nov. 11, 2010

(54) ACOUSTIC STEERING FOR BOREHOLE PLACEMENT

(75) Inventors: Bruce E. Cornish, Spring, TX (US); Michael S. Bittar, Houston, TX (US)

Correspondence Address: SCHWEGMAN, LUNDBERG & WOESSNER, P.A., P.O. BOX 2938, MINNEAPOLIS, MN, 55402, US

(73) Assignee: Halliburton Energy Services, Inc., Houston, TX (US)

(21) Appl. No.: 12/670,776

(22) PCT Filed: Dec. 6, 2007
(86) PCT No.: PCT/US07/24979

§ 371 Date: Aug. 2, 2010

(51) Int. Cl. G01S 3/80

(52) U.S. Cl. 367/124

(57) ABSTRACT

Apparatus (100), systems (110), and methods may operate to generate acoustic emissions from within at least a first borehole (120), receive the acoustic emissions within a second borehole (136), and process the acoustic emissions to locate a borehole bit (132) in formational space as the borehole bit is steered along a path within one of the first borehole or the second borehole. The acoustic emissions may be received by a plurality of acoustic receivers arranged in several ways, including linear and planar arrays. Additional apparatus, systems, and methods are disclosed.

### BACKGROUND INFORMATION

Steam-assisted gravity drainage and similar techniques have been developed to reduce the viscosity of heavy oils, thereby increasing producible reserves in geological formations. In some cases, a series of horizontally-spaced injection wells may be constructed so as to lie above a series of horizontally-spaced production wells, where the injection and production boreholes are only about five meters apart.

### BRIEF DESCRIPTION OF THE DRAWINGS

FIG. 1 illustrates apparatus and systems using acoustic receivers according to various embodiments of the invention.

FIG. 2 illustrates apparatus and systems using acoustic sensors located in the drill string according to various embodiments of the invention.

FIG. 3 illustrates apparatus and systems using one or more acoustic sources located in the drill string according to various embodiments of the invention.

FIG. 4 illustrates systems according to various embodiments of the invention.

FIG. 5 is a flow chart illustrating several methods according to various embodiments of the invention.

FIG. 6 is a block diagram of an article according to various embodiments of the invention.

### DETAILED DESCRIPTION

The inventors have discovered that the efficiency of gravity drainage techniques may increase with the placement accuracy of injection boreholes in relation to production boreholes. Thus, as an injection borehole is created, it can be useful to accurately determine its spatial relationship to one or more existing production boreholes within the formational space (i.e., three-dimensional space within a geological formation).

The inventors have further discovered that a mechanism for locating boreholes as they are created may be realized by using an array of acoustic receivers to locate a borehole bit as it moves through a geological formation. That is, the acoustic receiver array may be located in one or more existing boreholes, and the acoustic emissions of the bit (sometimes known to those of ordinary skill in the art as the drill bit “pilot signal”) that arise as the bit creates a new borehole can be monitored and located within the formation. In some embodiments, acoustic sensors are located additionally, or alternatively, in the borehole being formed. In some embodiments, one or more sources of acoustic emission are located in existing boreholes. The use of additional receivers and sources can provide improved borehole location resolution, in contrast with more conventional methods.

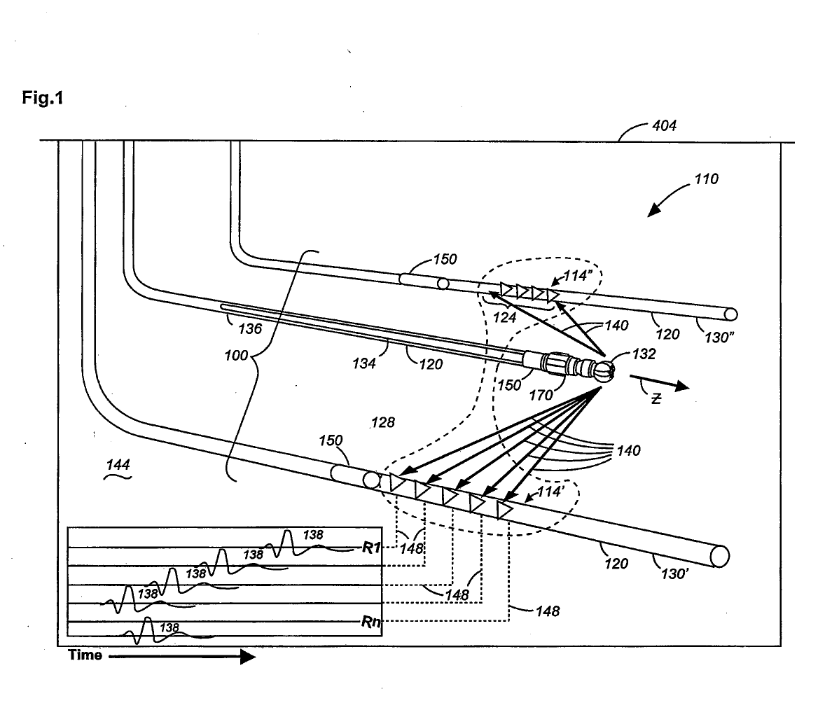

FIG. 1 illustrates apparatus 100 and systems 110 using acoustic receivers 114 according to various embodiments of the invention. For example, in the illustrated example, the acoustic receivers 114 may comprise one or more scalar sensors (e.g., strain gauges or pressure sensors, such as hydrophones) and/or one or more vector sensors (e.g., tri-axial accelerometers, or geophones), as well as combinations thereof. The acoustic receivers 114 can be placed in one or more observation locations, such as within the boreholes 120, perhaps forming one or more linear arrays 124, a planar array 128, or multiple planar arrays 128. The acoustic receivers 114 may be distributed in two or three dimensions within a single borehole 120 or across multiple boreholes 120 to improve directional accuracy with respect to the received signals 138.

Thus, a series of acoustic receivers 114 may be placed in one or more existing boreholes 130 to track the acoustic emissions (i.e., the transmitted waves 140) of a drill bit 132 coupled to a drill string 134 as the drill string 134 rotates to create a new borehole 136. The received signals 138 resulting from the transmitted waves 140 can be processed to extract range data, that can in turn be used to adjust the drilling direction Z, where Z is a vector in formational space.

Relative waveform arrival time within a geological formation 144 is dependent on the source-receiver distance and the average velocity of the intervening earth material along the transmitted wave 140 ray path. Thus, using velocity field information, range information from the receivers 114 to the bit 132 (or other source of acoustic emissions) can be determined from arrival time measurements 148 at the known locations of the receivers 114. The velocity field of the geological formation 144 may be known from independent sources (e.g., derived from acoustic logging measurements gathered from the existing boreholes 130, combined with seismic profile information). Alternatively, if the position of the seismic source (e.g., the drill bit 132) is known, computation of time stepout parameters may permit the derivation of the velocity field within the formation 144. In each case, the location of the bit 132 in formational space includes determining both the direction and the distance of the bit 132 with respect to the receivers 114.

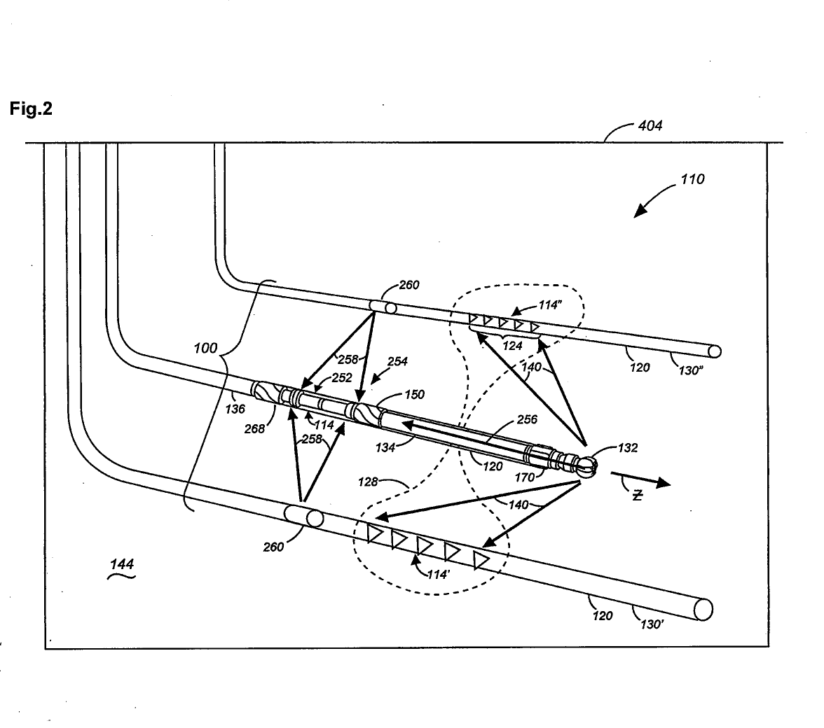

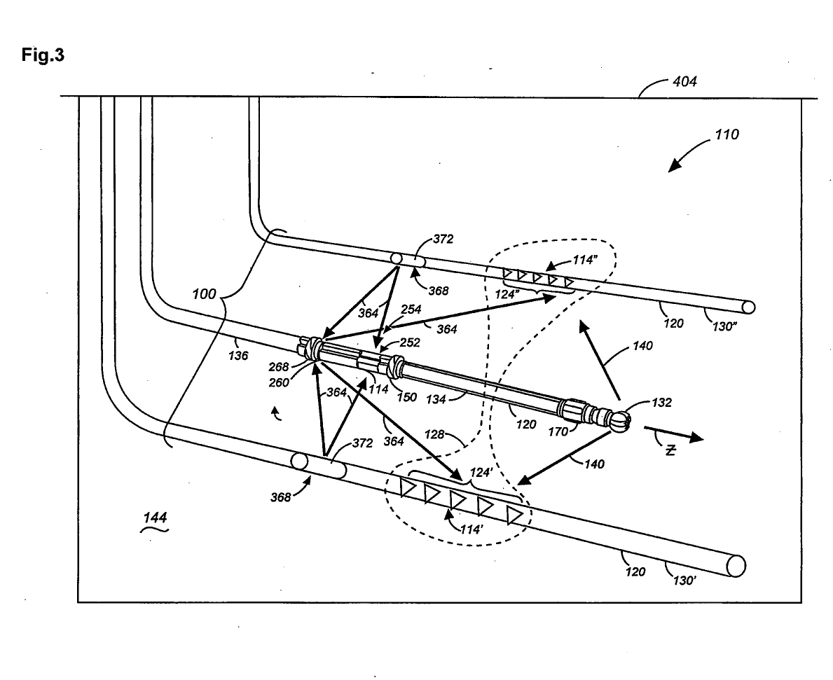

In most cases, the use of arrays 124, 128 can provide better results than the use of a single receiver 114. Processing techniques that account for different acoustic propagation modes in the formation 144 (e.g., pressure waves versus shear waves) may also improve the measurement accuracy. In addition, although not shown in FIG. 1, it should be understood that other sources of acoustic emission may be used to augment the emissions provided by the drill bit 132. The use of such auxiliary sources can improve the accuracy of locating the bit 132 in formational space with respect to the receivers 114, as will be discussed with respect to FIGS. 2 and 3.

As is well-known to those of ordinary skill in the art, a cross-correlation process may be used to compress received signals 138 resulting from the transmitted waves 140 to obtain time and amplitude relationships between different receivers 114. Moreover, cross-correlation enables the isolation of different wave modes and improves the signal-to-noise ratio of the received signals 138 resulting from the transmitted waves 140. Readers that wish to learn more about cross-correlation of signals received by acoustic receivers are encouraged to consult “The Use of Drill-Bit Energy as a Downhole Seismic Source”, J. W. Rector, III, et al., Geophysics, Vol. 56, No. 5, pp. 628-634, 1991.

The cross-correlation process may be implemented by an electronic module or processor located in one or more processing modules 150. Thus, the apparatus 100 may include an acoustic processing module 150 to locate the borehole bit 132 as the borehole bit 132 is steered along a path Z in the geological formation 144. A steering module 170 may receive manual or automated input to steer the borehole bit 132 as it cuts into the formation 144 to form the borehole 136.

FIG. 2 illustrates apparatus 100 and systems 110 using acoustic sensors 252 located in the drill string 134 according to various embodiments of the invention. Those elements of FIG. 2 having the same numbers as elements shown in FIG. 1 can be similar to or identical to those elements of FIG. 1. Sensors 252 may be similar to or identical to receivers 114 of FIG. 1.

In some embodiments, as shown in FIG. 2, a measurement-while-drilling (MWD) acoustic tool 254, sometimes known as a logging-while-drilling (LWD) device, is included in the drill string 134 in order to record the pilot signal 256 of the downhole drill bit 132 for cross-correlation with reception of the transmitted waves 140, compressing the received signals (see element 138 of FIG. 1) to obtain improved resolution. Thus, in some embodiments, linear and planar sensor arrays 124, 128 may be located in the new borehole 136, either apart from or integral with the drill string 134, perhaps forming part of the acoustic tool 254.

In some embodiments, the MWD acoustic tool 254 included in the drill string 134 may operate to record emissions (e.g., transmitted waves 258) from sources 260 purposely located in one or more of the boreholes 120. Recording operations may be conducted during normal pauses in the drilling operation in some cases. Thus, in addition to, or as an alternative to the cross-correlation process described above, one or more purpose-built acoustic sources 260 may be added to the apparatus 100. The excitation of these sources 260, and reception of the resulting transmitted waves 258, may be synchronized with a high-accuracy clock 268. Each source 260 may comprise one or more separate sources 260 of acoustic emission, and if made up of multiple sources, may be arranged in a localized grouping, as a linear array, or as a planar array within each one of the boreholes 120, or among multiple boreholes 120.

FIG. 3 illustrates apparatus 100 and systems 110 using one or more acoustic sources 260 located in the drill string 134 according to various embodiments of the invention. Those elements of FIG. 3 having the same numbers as elements shown in either FIG. 1 or 2 can be similar to or identical to those elements of FIGS. 1 and/or 2.

In this case, an MWD acoustic tool 254 is included in the drill string 134 to produce and record waves 364 from the sources 260 with the objective of targeting, by reflection seismology, impedance contrasts 368 located in or around an adjacent borehole. Impedance contrasts 368 within the formation 144 may be obtained, for example, by noting the existence of fluid 372 in the boreholes 120. In some cases, the impedance contrasts 368 may arise as the result of specially-designed structure placed in the boreholes 120. In some embodiments, the waves 364 received and recorded by the acoustic tool 254 are also received by acoustic sensors 114 located remotely from the new borehole 136, perhaps in existing boreholes 130. The data derived from this type of dual-acquisition operation may provide better results than reception and recording of the waves 364 by either of the acoustic tool 254 or the acoustic sensors 114 alone. Thus, as is the case with FIG. 2, one or more purpose-built acoustic sources 260 may be added to the apparatus 100. Here it can be seen that auxiliary acoustic source(s) 260 (having acoustic emissions which augment those provided by the primary source, or bit 132) can be located in the same borehole 136 as the bit 132, perhaps attached to or forming part of the acoustic too 254. In a similar fashion, the excitation of these sources 260, and reception of the resulting transmitted waves 364, may be synchronized with a high-accuracy clock 268.

Thus, referring now to FIGS. 1-3, it can be seen that many embodiments may be realized. For example, an apparatus 100 may comprise one or more acoustic receivers 114 placed in one or more boreholes 130, with one or more acoustic sources (e.g., the drill bit 132 and/or sources 260) in another borehole 136, as well as in the boreholes 130. More formally, an apparatus 100 to locate an acoustic source may comprise a first plurality of acoustic receivers 114′ to be located within a first borehole 130′ in a geological formation 144. The first plurality of receivers 114′ are to receive acoustic emissions (e.g., transmitted waves 140) from a second borehole 136 as the second borehole 136 is formed in a geological formation 144 using a borehole bit 132. The apparatus 100 may also include an acoustic processing module to locate the borehole bit as the borehole bit is steered along a path in the geological formation.

As noted above, the first plurality of acoustic receivers 114′ may be arranged as a substantially linear series (e.g., a linear array 124) and/or a substantially planar array 128. For example, a planar array 128 might be made up of three receivers forming a triangle, or more than three receivers forming an arc or some other planar shape. In some cases, the arc might form most of a circle. Thus, a multiplicity of receivers 114 might be located in one, two, or more boreholes 120, and portions of the entire set of receivers 114′, or the entire set of receivers 114 (comprising receivers 114′, 114″) may geometrically comprise a plane or arc of observations such that a triangulation approach might be used to obtain a global solution to the source location problem, which includes distance, azimuth angle, and elevation angle terms.

In some embodiments, the apparatus 100 may comprise one or more sensing devices (e.g., acoustic sensors 252) in the second borehole 136 to be attached to a drill string 134. The sensing devices may be used to receive a drill bit pilot signal 256 that can also be received by the first plurality of acoustic receivers 114′ (in the form of transmitted waves 140). The sensing devices may be housed by a downhole tool, such as the acoustic tool 254.

Additional sets of acoustic receivers may be used. Thus, the apparatus 100 may include a second plurality of acoustic receivers 114″ to be located in a third borehole 130″ in the geological formation 144, wherein the first and the second pluralities of acoustic receivers 114′, 114″ form a substantially planar array. A cross-correlation module, perhaps as part of a processing module 150, might be included to process received signal 138 waveforms associated with emissions from the acoustic source(s) (e.g., drill bit 132 and/or sources 260). Thus, the apparatus 100 may comprise one or more acoustic sources to provide acoustic emissions (e.g., the transmitted waves 140, 258, 364). The acoustic sources may comprise electronic sources 260 attached to a drill string 134.

In some embodiments, a pair of linear arrays 124′, 124″ may be disposed in two separate boreholes 130′, 130″ as part of the apparatus 100. The arrays 124′, 124″ may also be disposed in one of the boreholes 130, and in the new borehole 136.

Other embodiments may be realized. For example, an apparatus 100 may include one or more sources 260 in one borehole 120, with receivers 114 in another borehole 136 being formed. That is, an apparatus 100 may comprise an acoustic source 260 to provide acoustic emissions (e.g., transmitted waves 258) within a first borehole 130′ in a geological formation 144, with a plurality of acoustic receivers 114, 252 to be located within a second borehole 136 as it is formed in the geological formation 144 by a borehole bit 132. The acoustic receivers 114, 252 may be used to receive acoustic emissions (e.g., transmitted waves 258) from the acoustic source 260. The apparatus 100 may include one or more acoustic processing modules 150 to locate the borehole bit 132 as the borehole bit 132 is steered along a path Z in the geological formation. Some or all of the receivers 114 may be located along the path Z (within the borehole 136).

In some embodiments, the apparatus 100 includes a synchronizing clock 268 to synchronize provision of the acoustic emissions (e.g., transmitted waves 258) by the acoustic source 260 with reception of the acoustic emissions by the plurality of acoustic receivers 114, 252. The apparatus 100 may thus include an acoustic tool 254 that comprises a plurality of acoustic receivers 114, 252. In some cases, the plurality of acoustic receivers 114, 252 may also be used to image the geological formation 144 proximate to the second borehole 136. The acoustic tool 254 may also house the acoustic source 260 in some embodiments.

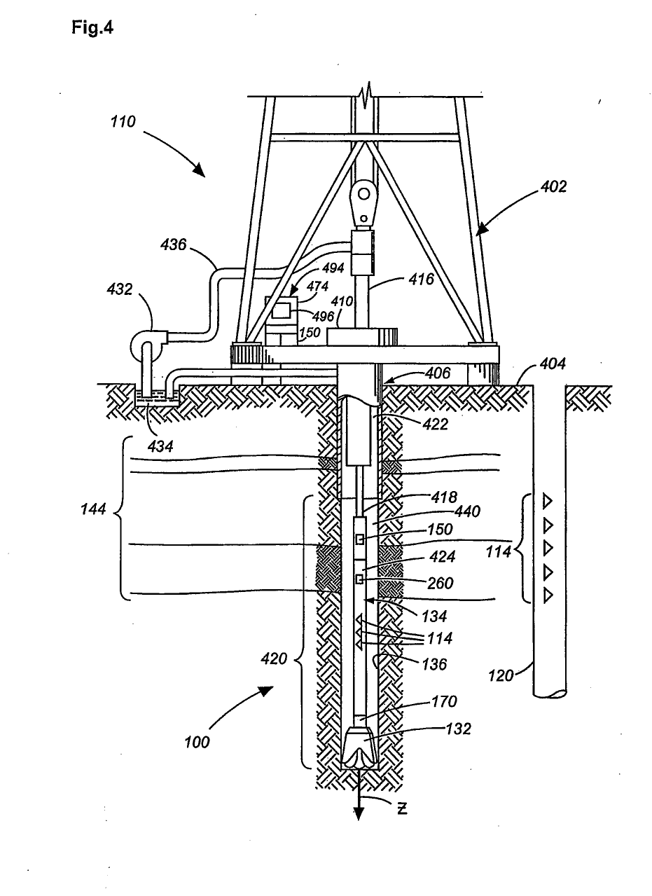

FIG. 4 illustrates systems 110 according to various embodiments of the invention. Those elements of FIG. 4 having the same numbers as elements shown in any of FIGS. 1-3 can be similar to or identical to those elements of FIGS. 1-3.

Here it can be seen that a system 110 may form a portion of a drilling rig 402 located at a surface 404 of a well 406. The drilling rig 402 may provide support for a drill string 134. The drill string 134 may operate to penetrate a rotary table 410 for drilling a borehole 136 through subsurface formations 144. The drill string 134 may include a Kelly 416, drill pipe 418, and a bottom hole assembly 420, perhaps located at the lower portion of the drill pipe 418.

The bottom hole assembly 420 may include drill collars 422, a downhole tool 424, and a drill bit 132. The drill bit 132 may operate to create a borehole 136 by penetrating the surface 404 and subsurface formations 144. The downhole tool 424 may comprise any of a number of different types of tools including MWD tools, LWD tools, and acoustic tools similar to or identical to the acoustic tool 254 of FIG. 2, and others.

During drilling operations, the drill string 134 (perhaps including the Kelly 416, the drill pipe 418, and the bottom hole assembly 420) may be rotated by the rotary table 410. In addition to, or alternatively, the bottom hole assembly 420 may also be rotated by a motor (e.g., a mud motor) that is located downhole. The drill collars 422 may be used to add weight to the drill bit 132. The drill collars 422 also may stiffen the bottom hole assembly 420 to allow the bottom hole assembly 420 to transfer the added weight to the drill bit 132, and in turn, assist the drill bit 132 in penetrating the surface 404 and subsurface formations 144.

During drilling operations, a mud pump 432 may pump drilling fluid (sometimes known by those of skill in the art as “drilling mud”) from a mud pit 434 through a hose 436 into the drill pipe 418 and down to the drill bit 132. The drilling fluid can flow out from the drill bit 132 and be returned to the surface 404 through an annular area 440 between the drill pipe 418 and the sides of the borehole 136. The drilling fluid may then be returned to the mud pit 434, where such fluid is filtered. In some embodiments, the drilling fluid can be used to cool the drill bit 132, as well as to provide lubrication for the drill bit 132 during drilling operations. Additionally, the drilling fluid may be used to remove subsurface formation 144 cuttings created by operating the drill bit 132.

Thus, referring now to FIGS. 1-4, it may be seen that in some embodiments, the system 110 may include a plurality of acoustic receivers 114 in one borehole 120 and one or more sources (e.g., drill bit 132 and/or sources 260) in another borehole 136 being formed. That is, a system 110 may include one or more apparatus 100.

Therefore, a system 110 may comprise a plurality of acoustic receivers 114 to be located within a first borehole 120 in a geological formation 144 and to receive acoustic emissions from a second borehole 136 as one of the first borehole 120 or the second borehole 136 is formed in a geological formation 144 using a borehole bit 132 (e.g., the locations of the receivers 114 and sources 132, 260 may be as shown in FIG. 4, or reversed, such that the receivers are located in borehole 136, and the sources 132 and/or 260 are located in borehole 120). That is, some of the plurality of acoustic receivers 114 may be attached to the downhole tool 424. While not shown in FIG. 4, it should be noted that multiple boreholes 120 may be present, each including multiple receivers 114, as shown in FIGS. 1-3.

In some embodiments, the system 110 may include an acoustic processing module 150 to locate the borehole bit 132 in the geological formation 144. The system 110 may also include a steering module 170 to direct the borehole bit 132 along a path Z in the geological formation 144, wherein the path Z is determined using one of manual input and automatic input based on feedback associated with a location of the borehole bit 132 provided by the acoustic processing module 150.

For example, manual input to the steering module 170 might be provided by an operator of a surface computer 492, perhaps based on the location of the borehole bit 132 presented in graphic form on a display 496 included in the system 110. In an automated system 110, the surface computer 492 may be programmed to provide automatic input to the steering module 170 based on feedback provided by the acoustic processing module 150.

In some embodiments, the surface computer 492 may include the acoustic processing module 150, or the acoustic processing module 150 may be divided between a surface installation and a subsurface installation for more efficient processing of acoustic data. The system 110 may comprise a data acquisition system 474 (perhaps included as part of the computer 496) to acquire velocity field information associated with the geological formation 144 and to provide the velocity field information to the acoustic processing module 150.

The apparatus 100; systems 110; acoustic receivers 114; boreholes 120, 130, 136; arrays 124, 128; drill bit 132; drill string 134; received signals 138; transmitted waves 140, 258, 364; formation 144; processing modules 150; acoustic sensors 252; acoustic tool 254; pilot signal 256; sources 260; clock 268; impedance contrasts 368; fluid 372; drilling rig 402; surface 404; well 406; rotary table 410; Kelly 416; drill pipe 418; bottom hole assembly 420; drill collars 422; downhole tool 424; mud pump 432; mud pit 434; hose 436; annular area 440; data acquisition system 474; surface computer 492; and display 496 may all be characterized as “modules” herein. Such modules may include hardware circuitry, and/or a processor and/or memory circuits, software program modules and objects, and/or firmware, and combinations thereof, as desired by the architect of the apparatus 100 and systems 110, and as appropriate for particular implementations of various embodiments. For example, in some embodiments, such modules may be included in an apparatus and/or system operation simulation package, such as a software electrical signal simulation package, a power usage and distribution simulation package, a power/heat dissipation simulation package, and/or a combination of software and hardware used to simulate the operation of various potential embodiments.

It should also be understood that the apparatus and systems of various embodiments can be used in applications other than for drilling operations, and thus, various embodiments are not to be so limited. The illustrations of apparatus 100 and systems 110 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, signal processing for geothermal tools and smart transducer interface node telemetry systems, among others. Some embodiments include a number of methods.

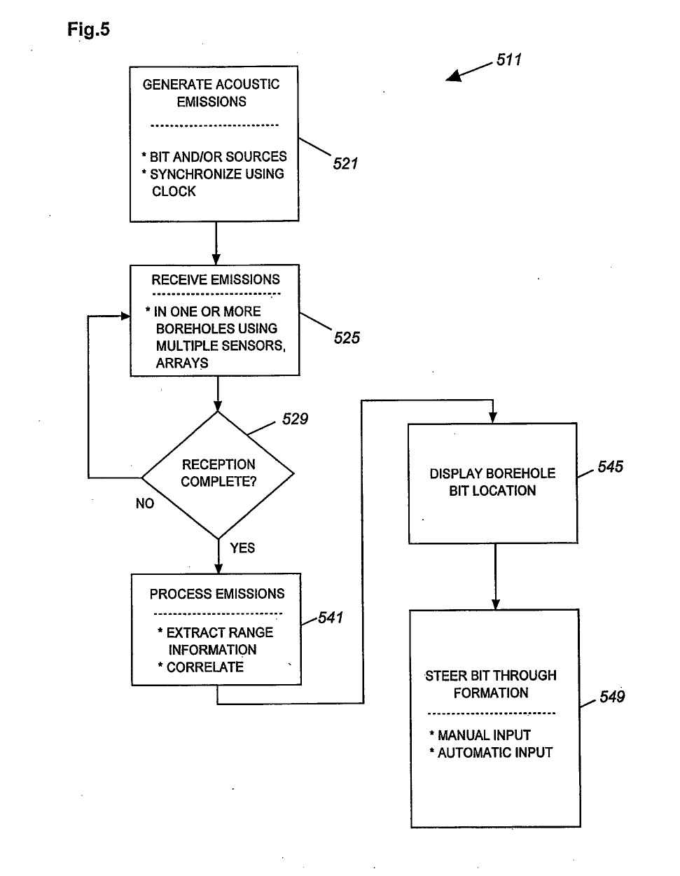

For example, FIG. 5 is a flow chart illustrating several methods 511 according to various embodiments of the invention. In some embodiments, a method 511 of creating a borehole using acoustic location and steering of the borehole bit may begin at block 521 with generating acoustic emissions from within a first borehole.

In some embodiments, generating at block 521 comprises generating the acoustic emissions using a borehole bit and/or an acoustic source attached to a tool mechanically coupled to the borehole bit. Generating at block 521 may also comprise synchronizing provision of the acoustic emissions to the reception time of the acoustic emissions using a common clock signal. Separately placed sources (e.g., sources 260 of FIG. 2) may also be used as part of the generating activities in block 521.

The method 511 may continue at block 525 with receiving the acoustic emissions within a second borehole. Emissions may be received in additional boreholes (e.g., third, fourth, etc.), as well. In some embodiments, receiving at block 525 may comprise receiving the acoustic emissions using a plurality of acoustic receivers located within at least one of the first borehole and the second borehole. The receivers may be operated singly, as part of a linear array, as part of a planar array, or as part of multiple arrays.

The method 511 may continue at block 529 with determining whether reception is complete. If not, then the method 511 may continue at block 525. If so, then the method 511 may continue with processing the acoustic emissions to locate a borehole bit as the borehole bit is steered along a path within one of the first borehole or the second borehole at block 541. In some embodiments, the processing at block 541 comprises extracting range information from a plurality of receivers to the borehole bit based on the acoustic emissions and a velocity field associated with the geological formation in which the first and the second borehole are located. Solutions can be refined by determining wave propagation modes and cross-correlation processing techniques (e.g., by observing the time difference between shear waves and p-waves). Thus, the processing of block 541 may also include correlating a location of the borehole bit based on reception of the acoustic emissions within the second borehole and a location of the borehole bit based on reception of the acoustic emissions within the first borehole.

In some embodiments, velocity field information associated with the geological formation may be acquired. This information may be used to adjust a model of the geological formation, and then the borehole bit may be located in formational space according to the adjusted model and the received acoustic emissions. Velocity field information can be acquired from perforated casing shots, seismic surveys, borehole profiles, and surface seismic profiles.

The method 511 may continue on to block 545 with displaying the location of the borehole bit in the geological formation, relative to various receivers, specially placed sources, the surface entry point of the borehole being created, and/or other boreholes. In some embodiments, the borehole bit can be located in the formation using grid search techniques, reverse time migration, seismic interferometry, and/or micro-earthquake location algorithms.

Thus, for example, seismic interferometry (a cross-correlation processing technique) can be used to further refine the solution; augmenting acoustic emission travel times with waveforms. The other techniques can be used in a similar manner to enhance location information derived from a simple velocity field model.

The method 511 may continue at block 549 with steering the borehole bit along a path is determined using manual input and/or automatic input, based on feedback associated with the location of the borehole bit provided by the processing at block 541.

In some embodiments, the method 511 may include receiving the acoustic emissions at a third borehole as part of the activity at block 525, and processing the acoustic emissions to locate the borehole bit with respect to the third borehole and at least one of the first borehole and the second borehole at block 541. The method 511 may also include, at block 549, steering the borehole bit within the first borehole along a path that is substantially parallel to the longitudinal axis of the second borehole. Many other methods may be realized.

It should be noted that the methods described herein do not have to be executed in the order described, or in any particular order. Moreover, various activities described with respect to the methods identified herein can be executed in iterative, serial, or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment. Thus, other embodiments may be realized.

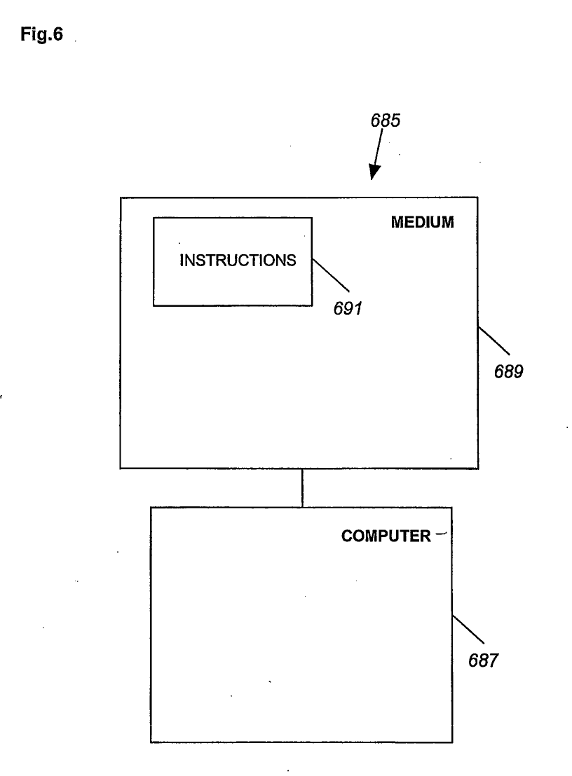

For example, FIG. 6 is a block diagram of an article 685 according to various embodiments of the invention, such as a computer, a memory system, a magnetic or optical disk, or some other storage device. The article 685 may include a computer-accessible medium 689 such as a memory (e.g., removable storage media, as well as any memory including an electrical, optical, or electromagnetic conductor) having instructions 691 (e.g., computer program instructions) stored thereon, which when accessed by the computer 687, results in the computer performing such actions as generating acoustic emissions from a first borehole, receiving the acoustic emissions at a second borehole, and processing the acoustic emissions to locate a borehole bit as the borehole bit is steered along a path within one of the first borehole and the second borehole.

Additional activities may include receiving the acoustic emissions at a third borehole, and processing the acoustic emissions to locate the borehole bit with respect to the third borehole and at least one of the first borehole and the second borehole. Further activities may include steering the borehole bit within the first borehole along the path, wherein the path is substantially parallel to a longitudinal axis of the second borehole. Thus, many other embodiments may be realized, including a machine-accessible medium 489 encoded with instructions 491 for directing the computer 487 to perform actions comprising any of the methods described herein.

Using the apparatus, systems, and methods disclosed herein may reduce discrepancies that arise when less precise mechanisms are used to locate multiple boreholes in close proximity to one another. Improved efficiency with respect to petroleum recovery operations may result.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, comprising:
a first plurality of acoustic receivers to be located within a first borehole in a geological formation and to receive acoustic emissions from a plurality of acoustic sources in a second borehole as it is formed in a geological formation using a borehole bit; and
an acoustic processing module to locate the borehole bit in formational space as the borehole bit is steered along a path in the geological formation.

2. The apparatus of claim 1, wherein the first plurality of acoustic receivers are arranged in at least one of a substantially linear series and a substantially planar array.

3. The apparatus of claim 1, comprising:
a sensing device in the second borehole to be attached to a drill string and to receive a drill bit pilot signal that is also to be received by the first plurality of acoustic receivers.

4. The apparatus of claim 1, comprising:
a second plurality of acoustic receivers to be located in a third borehole, wherein the first and the second pluralities of acoustic receivers form a substantially planar array.

5. The apparatus of claim 1, wherein the plurality of acoustic sources comprise at least one electronic source attached to a drill string.

6. An apparatus, comprising:
a plurality of acoustic sources to provide acoustic emissions within at least a first borehole in a geological formation;
a plurality of acoustic receivers to be located within a second borehole as it is formed in the geological formation by a borehole bit, and to receive acoustic emissions from the plurality of acoustic sources; and
an acoustic processing module to locate the borehole bit in formational space as the borehole bit is steered along a path in the geological formation.

7. The apparatus of claim 6, comprising:
a synchronizing clock to synchronize provision of the acoustic emissions by at least one of the plurality of acoustic sources with reception of the acoustic emissions by the plurality of acoustic receivers.

8. The apparatus of claim 6, comprising:
an acoustic tool including the plurality of acoustic receivers.

9. The apparatus of claim 8, wherein the acoustic tool houses at least one of the plurality of acoustic sources.

10. A system, comprising:
a plurality of acoustic receivers to be located within a first borehole in a geological formation and to receive acoustic emissions from a plurality of acoustic sources within at least a second borehole as one of the first borehole or the second borehole is formed in a geological formation using a borehole bit;
an acoustic processing module to locate the borehole bit in formational space in the geological formation; and
a steering module to direct the borehole bit along a path in the geological formation, wherein the path is determined using one of manual input and automatic input based on feedback associated with a location of the borehole bit provided by the acoustic processing module.

11. The system of claim 10, comprising:
a display to present the location of the borehole bit in graphic form.

12. The system of claim 10, comprising:
a downhole tool, wherein at least some of the plurality of acoustic receivers are attached to the downhole tool.

13. The system of claim 10, further including:
a data acquisition system to acquire velocity field information associated with the geological formation and to provide the velocity field information to the acoustic processing module.

14. A method, comprising:
generating acoustic emissions from a plurality of acoustic sources within at least a first borehole located in a geological formation;
receiving the acoustic emissions within a second borehole located in the geological formation; and
processing the acoustic emissions to locate a borehole bit in formational space as the borehole bit is steered along a path within one of the first borehole or the second borehole.

15. The method of claim 14, wherein the generating comprises:
generating the acoustic emissions using at least one of the borehole bit or an electronic acoustic source attached to a tool mechanically coupled to the borehole bit.

16. The method of claim 14, wherein the generating comprises:
synchronizing provision of the acoustic emissions to a reception time of the acoustic emissions using a common clock signal.

17. The method of claim 14, wherein the receiving comprises:
receiving the acoustic emissions using a plurality of acoustic receivers located along the path.

18. The method of claim 14, wherein the processing comprises:
extracting range information from a plurality of receivers to the borehole bit based on the acoustic emissions and a velocity field associated with the geological formation.

19. The method of claim 14, comprising:
correlating a location of the borehole bit based on reception of the acoustic emissions within the second borehole and a location of the borehole bit based on reception of the acoustic emissions within the first borehole.

20. The method of claim 14, wherein the receiving comprises:
receiving the acoustic emissions using a planar array of acoustic receivers.

21. The method of claim 14, comprising:
displaying a location of the borehole bit in the geological formation.

22. The method of claim 14, comprising:
steering the borehole bit along the path, wherein the path is determined using one of manual input and automatic input based on feedback associated with a location of the borehole bit provided by the processing.

23. An article including a computer-accessible medium having instructions stored thereon, wherein the instructions, when accessed by a computer, result in the computer performing:
generating acoustic emissions from a plurality of acoustic sources within at least a first borehole located in a geological formation;
receiving the acoustic emissions within a second borehole located in the geological formation; and
processing the acoustic emissions to locate a borehole bit in formational space as the borehole bit is steered along a path within one of the first borehole or the second borehole.

24. The article of claim 23, wherein the instructions, when accessed, result in the computer performing:
receiving the acoustic emissions at a third borehole; and
processing the acoustic emissions to locate the borehole bit with respect to the third borehole and at least one of the first borehole and the second borehole.

25. The article of claim 23, wherein the instructions, when accessed, result in the computer performing:
steering the borehole bit within the first borehole along the path, wherein the path is substantially parallel to a longitudinal axis of the second borehole.
